(19) United States
(12) Patent Application Publication
(10) Pub. No.: US 2009/0085318 A1
(43) Pub. Date: Apr. 2, 2009

(54) Vehicle leaf spring suspension with radius arms

(76) Inventor: Brian Scott Guthrie, Carmel, IN (US)

Correspondence Address: THOMTE LAW OFFICE, L.L.C., 2120 S. 72ND STREET, SUITE 1111, OMAHA, NE, 68124, US

(21) Appl. No.: 11/904,833

(22) Filed: Sep. 28, 2007

(51) Int. Cl. B60G 11/04

(52) U.S. Cl. 280/124.11; 267/36.1

(57) ABSTRACT

A vehicle suspension comprising a pair of leaf springs arranged to extend longitudinally of the frame of a vehicle on opposed sides thereof with each leaf spring having one of its ends pivotally connected to the vehicle frame at a fixed location and which have an axle secured thereto between the ends thereof. A first bracket rigidly attaches each leaf spring at or adjacent the fixed location where the end of the leaf spring is connected to the vehicle frame. A radius arm extends longitudinally on each side of the vehicle frame and has one end thereof pivotally connected to the first bracket in a spaced-apart relationship to the fixed location. A second bracket is rigidly attached to the axle and is connected to the other end of the corresponding radius arm in a spaced relationship to the axle. Modified versions of the suspension are also disclosed.

### CROSS-REFERENCE TO RELATED APPLICATION

This application claims priority from PCT application Serial No. PCT/US2005/016269 filed May 10, 2005, and published as International Publication No. WO 2006/121438 on Nov. 16, 2006.

### FIELD OF THE INVENTION

This invention relates to a vehicle leaf spring suspension with radius arms.

### BACKGROUND OF THE INVENTION

In vehicle suspensions where the axles are mostly located and controlled by leaf springs, many compromises have to be made. Such compromises can adversely reflect on the suspension performance under various loading conditions to which it is subjected during the operation of the vehicle.

When a vehicle axle is loaded and located with “symmetrical” and “conventional” leaf springs, the axle will deflect, on the suspension, without any change in angle, if any effect from the rear location is ignored.

Throughout this specification, the terms “symmetrical” and “conventional” are as used generally in the suspension industry and defined in the SAE Leaf Spring Design Manual SAE J788.

Conventionally, an axle is located by a fixed front eye and an effective link provided by a forward section of the leaf spring between the front eye and axle, with the centre section of the leaf spring moving up and down on the two effective links of equal length fore and aft of the axle. As the position of the front eye is fixed, any point around the axle moves on an effective parallelogram linkage. As the axle angle does not change the effective instantaneous centre of the axle assembly is at infinity.

There are many advantages or characteristics associated with this type of installation, one being that linkages or drivelines connected to the axle, such as propeller shafts and steering rods, can maintain constant or equal angles during the suspension deflections, namely, the axle does not revolve as the suspension deflects.

The braking and traction forces acting on the vehicle effectively act at the tyre ground contact point and create a torque around the spring front location eye. This is resisted by the axle to vehicle suspension system.

In this context, another important advantage with a symmetrical leaf spring suspension system is that this torque will not create lifting or lowering forces or motions, which means that the suspension height stays as a linear function of the vertical imposed weight. The suspension will not create any dive or squat under braking or traction forces with the effective instantaneous centre point at infinity. Therefore, any braking, traction or load sensing control devices, working from the suspension height or pressure, will stay more accurate and effective under these braking and traction loads. On softly sprung vehicles, spring wind-up can cause problems. As a result of the above features, symmetrical leaf spring suspensions can absorb this wind-up more readily.

A further advantage with symmetrical leaf springs is that the vertical stiffness of the suspension, under direct vertical loads, is a linear summation of the rates of the two leaf spring cantilevers, this being the most efficient use of the spring material.

A characteristic, and sometimes a disadvantage of symmetrical springs, is that the anti-roll stiffness of the suspension is just a function of the spring vertical and torsional stiffnesses and the spring spacing width across the vehicle.

As leaf springs become less symmetrical, with one cantilever being stiffer than the other, the axle has to change its angle as the suspension deflects. The effective links for and aft of the axle are now of unequal lengths and each cantilever deflects by a different amount. In moderate amounts, this lack of symmetry can usually be accommodated without any major compromises. As the instantaneous centre of the axle area now becomes finite and the effective swing arm length becomes shorter, there is a degree of axle lift or squat under braking or traction forces. This can normally be accommodated in full leaf spring suspension applications.

The vertical stiffness of the suspension for ride quality is now stiffer than the sum of the stiffnesses of the two spring cantilevers and is therefore less efficient. Also, softly sprung vehicles are often more sensitive to wind-up under braking or traction.

During vehicle roll, the leaf springs on each side of the vehicle deflect in different directions. A characteristic with asymmetrical springs that sometimes is an advantage is that, during roll, the axles try to change their angles in different directions. As the axles are normally relatively torsionally stiff, the axle will not allow any change in the angle, and this distorts the springs, making them effectively stiffer. This creates extra anti-roll stiffness when using asymmetrical leaf springs.

This characteristic is taken to extremes when leaf springs are used to locate axles with offset air springs. This type of suspension effectively creates a very asymmetrical spring installation, with the rear, air spring cantilever being much softer than the front, locating leaf spring cantilever.

As air springs have virtually no internal friction, air spring suspensions require very high extra anti-roll stiffnesses. This high roll stiffness is required for both cornering, roll control and straight ahead vehicle stability. The required high anti-roll stiffness is usually created by using a very stiff, front leaf spring cantilever, with the previously discussed axle twisting effect.

In many cases, the front leaf spring cantilever effectively just becomes a radius arm. This means that the instantaneous centre of the axle area is virtually at the front eye. This has several disadvantages, one being that the system's deflection stiffness becomes high. If the leaf spring cantilever is effectively rigid, the system's stiffness is the air spring stiffness increased by the square of the distance (La) which the air spring is spaced from the front eye divided by the front cantilever length (Lc). This means that the air spring has to be very soft to create only a moderate, suspension softness. This is very inefficient and expensive.

Thus as the instantaneous centre of the system is at the front eye:—

Axle vertical stiffness=air spring stiffness×(La/Lc)²

Also, under braking and traction forces, there tends to be a very high axle lifting or squatting effect due to the very large difference in deflection between the cantilevers and short effective axle instantaneous centre arm. This leads to adhesion instability and makes the electronic or other accurate, load height sensing for braking and traction very difficult. It can also lead to adverse propeller shaft, universal joint angles, which increases vehicle vibrations and creates poor drive system durability.

To reduce these braking and traction height and axle angle changes, many of these air suspension applications have lowered front eyes. This reduces the moment distance from the ground contact point and, thus, the moment which the suspension has to absorb.

However, this creates structural problems in the frame suspension attachment area. The braking force acts through the front eye and as this is now at an increased distance from the vehicle frame, the frame, the front eye and bracket fastenings to the frame, are subjected to much higher loads. This requires stronger and wider spaced frame fasteners and mountings, with the frame and cross members usually requiring extra reinforcements.

Many air suspension applications are options to standard steel, leaf spring suspensions. The need to lower the front eye for these designs requires special frame assemblies for the optional air suspension, leading to production line complications which often make air suspension options very expensive.

If the suspension's anti-roll stiffness could be provided by means other than the above “axle twisting” effect, the front leaf spring cantilever could be softened. This would immediately improve the suspension's performance. The effective instantaneous centre line would increase in length and be well forward of the front eye. This would soften the suspension by both the softer front cantilever deflection and by making the air spring rate closer to the axle suspension rate. Adding an extra, conventional anti-roll bar system to an air suspension, to retain the required high anti-roll stiffness, makes these air suspension systems very heavy and expensive.

There is also another problem which often prevents the above improvement to the suspension from being adopted. As previously discussed, on a leaf spring suspension, the spring and axle wind-up under braking and traction Is a function of the moment created by the force at the ground contact and the vertical distance to the front eye. This moment is absorbed and reacted to over the length of the overall leaf spring. As stated above, most leaf spring applications can absorb this moment, although the wind-up can limit the degree to which the springs can be softened, especially with short spring installations or high spring installations, such as with solid front drive axles.

Considering some air spring applications, the effective length of the leaf springs is severely reduced from a full leaf spring suspension to one with an air suspension. This effectively increases the forces on each leaf spring cantilever, whereby another design pressure contributes to the expensive lowering of the front eye.

An attempted solution to this wind-up problem which is sometimes currently employed, is to build in an anti-wind-up linkage. However, this type of linkage creates more high frame loading problems than the attempted “lowering of the front eye” improvement.

A braking force at the ground contact point would require a reaction of at least twice the braking force along the link and a force at least equal to the braking force at the spring eye. The offset frame bracketry required to support and control the link would need to be more substantial than that required for just lowering the front eye.

Another well known air suspension arrangement has the normal full length leaf spring replaced by a lighter leaf spring which locates the axle and often just carries the unladen vehicle suspension loads. The air spring which is usually located close to the axle centre line, carries the remainder of the load applied to the suspension when the vehicle is loaded. Thus, this suspension has a leaf spring and air spring operating in parallel.

With these arrangements, the friction from the leaf spring is again very limited and the high extra anti-roll force is again required. Also, the leaf spring still provides solely the only resistance to braking and traction wind-up. As this leaf spring carries only part of the load, it now is so much lighter than the original, solo leaf spring. Therefore, axle wind-up control is now a major problem.

Alternatively, the leaf spring can be stiffened up to create adequate control but as the air spring is now in parallel with the leaf spring, the combined suspension would now have a very stiff deflection rate. This defeats one of the main reasons for specifying this expensive suspension. These factors can severely restrict the performance of these known suspension arrangements.

To improve partially these wind-up and roll stiffness restrictions, the leaf spring is often designed to hare high asymmetrical stiffness which then moves the suspension in to the problem areas discussed with the earlier air suspensions. It is also a very expensive and inefficient use of spring materials. Sometimes the rear cantilever of the leaf spring is removed altogether and replaced with a transverse linkage to laterally locate the axle.

### OBJECT OF THE INVENTION

It is an object of the present invention to provide a vehicle leaf spring suspension which overcomes, or at least substantially reduces, the disadvantages associated with the prior art suspensions discussed above.

### SUMMARY OF THE INVENTION

A first aspect of the invention resides in a vehicle suspension comprising:
a pair of leaf springs arranged to extend longitudinally of a frame of an associated vehicle on respective opposed sides thereof, each leaf spring having one of its ends connectable pivotally to the vehicle frame at a fixed location with respect thereto and arranged to have mounted thereto intermediate its ends an axle extending transversely of the vehicle frame;
a first bracket attached rigidly to each leaf spring at or adjacent the fixed location at which the one end of each leaf spring is connectable pivotally to the vehicle frame;
a radius arm arranged to extend longitudinally on each side of the vehicle frame and having an end thereof connected pivotally to the first bracket in spaced relationship to said fixed location; and
a second bracket which is attachable rigidly to the axle and to which is connected the other end of the corresponding radius arm in spaced relationship to the axle.

A second aspect of the invention provides a vehicle suspension assembly comprising a vehicle suspension and an axle, the vehicle suspension comprising:
a pair of leaf springs arranged to extend longitudinally of a frame of an associated vehicle on respective opposed sides thereof, each leaf spring having one of its ends connectable pivotally to the vehicle frame at a fixed location with respect thereto and having mounted thereto intermediate its ends the axle which is arranged to extend transversely of the vehicle frame;
a first bracket attached rigidly to each leaf spring at or adjacent the fixed location at which the one end of each leaf spring is connectable pivotally to the vehicle frame;
a radius arm arranged to extend longitudinally on each side of the vehicle frame and having an end thereof connected pivotally to the first bracket in spaced relationship to said fixed location; and
a second bracket which is attached rigidly to the axle and to which is connected the other end of the corresponding radius arm in spaced relationship to the axle.

A third aspect of the invention resides in a vehicle comprising a frame, a suspension and an axle, the suspension comprising:
a pair of leaf springs extending longitudinally of the frame of the vehicle on respective opposed sides thereof, each leaf spring having one of its ends connected pivotally to the vehicle frame at a fixed location with respect thereto and having mounted thereto intermediate its ends the axle which extends transversely of the vehicle frame;
a first bracket attached rigidly to each leaf spring at or adjacent the fixed location at which the one end of each leaf spring is connected pivotally to the vehicle frame;
a radius arm extending longitudinally on each side of the vehicle frame and having an end thereof connected pivotally to each first bracket in spaced relationship to said fixed location; and
a second bracket which is attached rigidly to the axle and to which is connected the other end of the corresponding radius arm in spaced relationship to the axle.

In each of the three aspects of the invention defined above, the one end of each leaf spring may include an eye, preferably a front eye, which can be or is connected pivotally to the vehicle frame at the fixed location with respect thereto by means of a bush which may be mountable or mounted in a hanger bracket fixable or fixed rigidly to the vehicle frame.

The other end of each leaf spring may be connectable or connected to the vehicle frame in any conventional manner for linear movement with respect thereto, to account for length changes of the spring under load conditions. For example, a bush, bush and shackle, slider bracket or air spring could be used for this purpose.

Either or both ends of each radius arm may be connected pivotally or rigidly to its respective bracket by means of a bush or a clamp, as the case may be. Also, each second bracket may be attached rigidly to an axle assembly of which the corresponding transverse end of the axle forms part. Each second bracket may be attached rigidly to the respective axle assembly by any suitable means, such as at least one U-bolt.

In practice, each leaf spring, and preferably the front cantilever thereof, the first and second brackets and the radius arm spaced from the leaf spring, form a linkage which may be generally parallelogram-shaped. This linkage may be tuned to the operative requirements of the suspension.

The suspension may include symmetrical or asymmetrical leaf springs.

With leaf spring-controlled suspensions of this type, there may be included further suspension means which may be in parallel or series with each leaf spring. The further suspension means may be mountable or mounted to the axle and/or each leaf spring, as the case may be. Such further suspension means may be of any suitable type, for example, an air spring, elastomeric spring or coil spring or any combination thereof.

### BRIEF DESCRIPTION OF THE DRAWINGS

In order that the invention may be more fully understood, embodiments of vehicle suspensions in accordance therewith will now be described by way of example and with reference to the accompanying drawings in which:

FIG. 1 is a diagrammatic side view of a prior art, symmetrical deflection, cantilevered leaf spring suspension, illustrating the leaf spring deflection geometry;

FIG. 2 is a diagrammatic side view of the prior art suspension shown in FIG. 1, illustrating axle wind-up when the associated vehicle is subjected to a braking force;

FIG. 3 is a diagrammatic side view of a prior art, unsymmetrical deflection, cantilevered leaf spring suspension, illustrating the associated spring deflection geometry;

FIG. 4 is a diagrammatic side view of a prior art air spring suspension incorporating a leaf spring radius arm mounted to the associated vehicle frame by a front eye bracket;

FIG. 5 is a diagrammatic side view of another prior art air spring suspension similar to that shown in FIG. 4 but with the leaf spring radius arm mounted to the vehicle frame by a lowered front eye bracket;

FIG. 6 is a diagrammatic side view of a modified version of the prior art suspension shown in FIG. 4 but with the addition of an anti-wind-up lower linkage and brackets;

FIG. 7 is a side view of another prior art air suspension which shares the load between a lighter leaf spring and an air spring acting in parallel;

FIG. 8 is a side view of a modified version of the prior art air suspension shown in FIG. 7;

FIG. 9 is a side view of a first embodiment of air suspension incorporating a leaf spring radius arm in accordance with the invention;

FIG. 10 is a perspective view of the first embodiment of suspension shown in FIG. 9;

FIG. 11 is a diagrammatic side view of a second embodiment of air suspension incorporating a radius arm in accordance with the invention; and

FIG. 12 is a diagrammatic side view of a third embodiment in accordance with the invention.

### DETAILED DESCRIPTION OF THE PRIOR ART

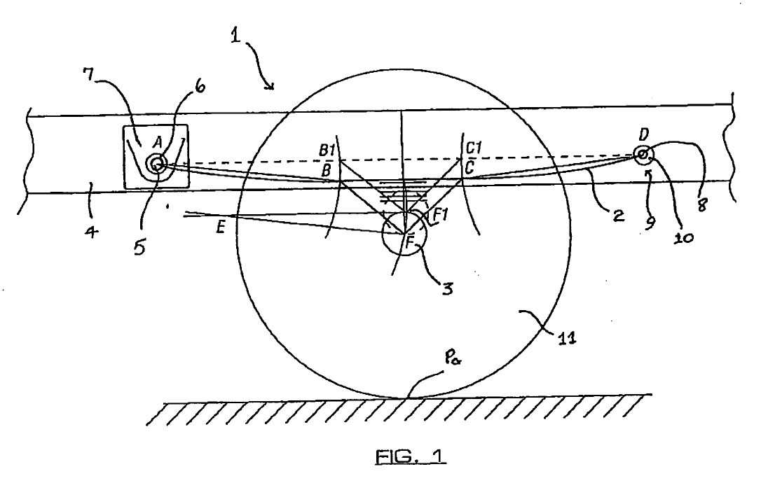

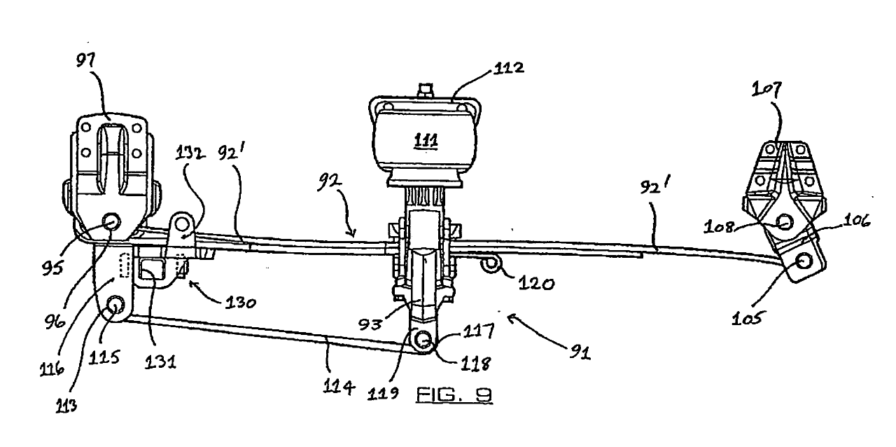

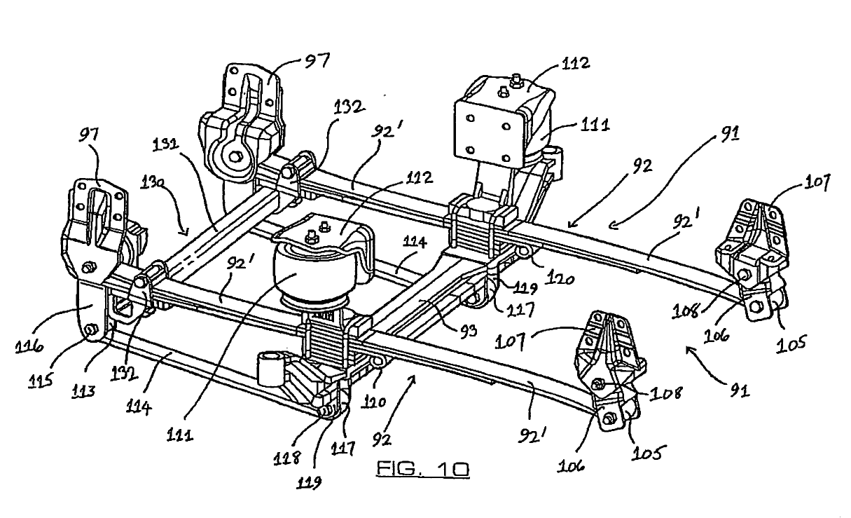

In the following examples of prior art suspensions, as shown in FIGS. 1 to 8, and embodiments of inventive suspensions, as shown in FIGS. 9 to 12, it is to be understood that even though each suspension comprises, inter alia, a pair of leaf springs extending longitudinally in the fore and aft direction of the frame of an associated vehicle on respective opposed transverse sides thereof, only one side of each suspension is illustrated, with the exception of FIG. 10 which is a perspective view of a first embodiment of inventive suspension.

Also, it is to be appreciated that in each prior art example and inventive embodiment of suspension, the fore or front end of each leaf spring is connected directly or indirectly to the frame of the associated vehicle at a fixed location with respect thereto by means of, say, a bush. Thus, the front end of each leaf spring can undergo pivotal movement with respect to the vehicle frame but not linear movement with respect thereto.

Referring firstly, therefore, to FIG. 1 of the accompanying drawings, a prior art, symmetrical deflection, cantilevered leaf spring suspension, indicated generally at 1, comprises a pair of leaf springs 2 (only one shown) extending longitudinally on respective opposed sides of a vehicle frame 4. Each leaf spring 2 is mounted generally centrally to an end of a transverse axle 3. The front end eye 5 of the leaf spring 2 is connected to the frame 4 of the associated vehicle at a fixed location point A by means of a bush 6 mounted within a front frame hanger bracket 7.

The aft or rear end of the leaf spring 2 is connected to the vehicle frame 4 for pivotal and linear movement with respect thereto, the latter movement taking into account the change of the length of the leaf spring 2 as its curvature changes under load. Such connection between the rear end eye 10 of the leaf spring 2 is indicated generally at 9 and may comprise a shackle or cam slider.

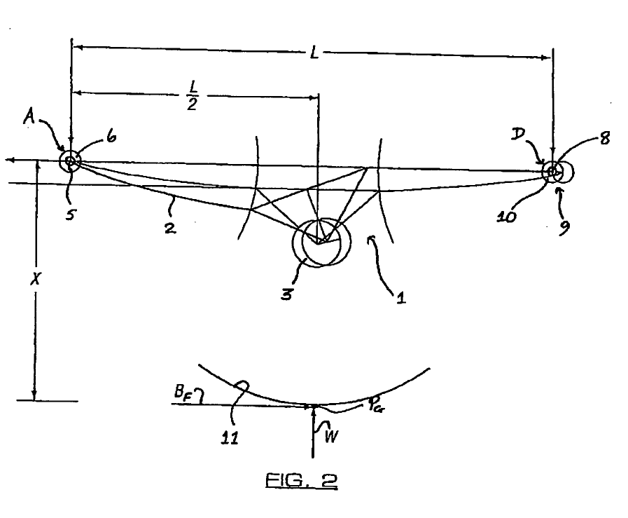

The added complexity of the movement of the leaf spring 2 is simplified by assuming that its rear eye location D moves horizontally during the change of length of the spring as it changes its curvature and deflects under differing loads and other operating conditions. In practice, movement of this location point D would be controlled by the manner in which it is mounted to the frame 4, for example, the shackle or cam slider 9 referenced above. Any change of height of that mounting would distort the instantaneous centre length of the leaf spring 2 which, in the prior art symmetrical suspension of FIG. 1 or FIG. 2, is at infinity.

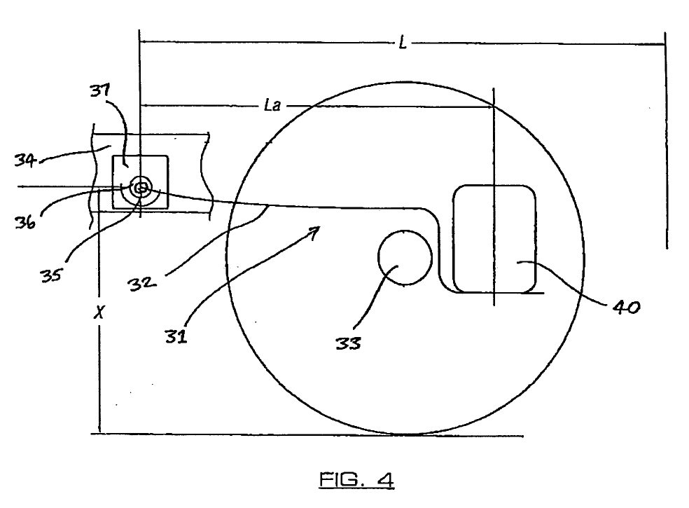

Also, the prior art suspension of FIG. 1 is based upon the layout construction arrangements specified in the SAE Manual of Leaf Springs (SAE HS788) and, in particular, is shown at FIG. 4.2 on page 29 of that Manual.

Thus, when the axle 3 is loaded and as it is located by symmetrical and conventional leaf springs 2, it will deflect on the suspension 1 without any change in angle, ignoring any effect from the location of the rear eye 10 of the leaf spring 2, as discussed above. The axle 3 is located with respect to the vehicle frame 4 by the fixed location of the front eye of the leaf spring 2 and the effective link section A-B of the leaf spring 2. The centre section B-C of the leaf spring 2 moves up and down on the two equal length link sections A-B and C-D. As the front eye 5 of the leaf spring 2 is fixed at A, any point around the axle 2 moves on an effective, generally parallelogram linkage ABFE, for example, point F around the virtual link section E-F as the angle of the axle 3 does not change, the effective instantaneous centre of the axle assembly is at infinity.

Thus, the deflection geometry of the suspension 1 is created by assuming that the centre section B-C of the leaf spring 2 in the region around the axle 3 is effectively dead or inoperative. The axle 3 is then located by the two link sections A-B and C-fl of the leaf spring 2, with the front eye fixed. These link sections A-B and C-D are typically about three quarters of the working length of each of the fore and aft cantilevers of the leaf spring 2. With this geometry, points on the axle will move in parallel arcs, for example, F will rotate about E, with the effective link section E-F parallel and equal in length to the link section A-B.

Under load, the axle 3 is located by the two link sections A-B1 and C1-D, with the virtual link section E-F1.

FIG. 2 shows the suspension 1 having the same spring geometry as that shown in FIG. 1 but under a braking force B_{F} at the ground contact point P_{G} of the running wheel 11 of the associated vehicle.

As discussed above, the braking and traction forces acting on the vehicle effectively act at the wheel ground contact point P_{G} and create a torque around the fixed location point A of the front end eye of the leaf spring 2. This torque is resisted by the axle 3 and suspension 1.

When the suspension 1 is static, the vertical force exerted on the ground due to the sprung weight W of the associated vehicle, is distributed evenly to the location points A, D at which the eyes 5 and 8 of the respective front and rear ends of the leaf spring 2 are connected to the vehicle frame 4.

Thus, each distributed vertical force is equal to W/2.

The braking force B_{F} creates a moment B_{F}×X around the front eye 5 of the leaf spring 2, which is resisted by extra vertical forces at the front and rear leaf spring location points A, D.

Thus, the static vertical force at the front eye 5 of the leaf spring 2 changes from W/2 to (W/2−B_{F}X/L) where X is the height of the location point A about ground level and L is the distance between the front and rear location points A, D of the leaf spring 2. As a consequence, the static rear vertical force changes from W/2 to (W/2+B_{F}X/L). The braking force B_{F} is also reacted by an equal horizontal force in the opposite direction at the front location point A of the leaf spring 2. A similar, but reversed, loading situation can occur under traction reaction torque, which reverses B_{F} for normal forward motion.

As the front and rear cantilevers of the leaf spring 2 now have lighter and heavier vertical loads, they deflect in different directions, thus causing the axle 3 to rotate. With the consequential deflection rates of these symmetrical cantilever suspensions, there is the same deflection change in each cantilever and, therefore, there is no change in the vertical height of the suspension.

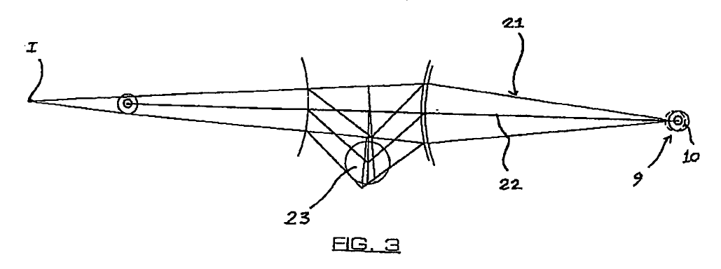

In FIG. 3, there is shown the vertical loading deflection geometry of a suspension 21 similar to that described above with reference to FIGS. 1 and 2 but with asymmetrical deflection, cantilevered leaf springs 22. Thus, the different stiffnesses of the front and rear cantilevers of the leaf spring 22 and the different reactive loads at each end thereof, create a rotation of the axle 23, as the spring 22 deflects under load. This deflection creates a finite, instantaneous centre, virtual arm length around which the axle 23 rotates as it deflects, as indicated at I. In a similar manner and with this asymmetrical deflection leaf spring suspension 21, the vertical height of the axle 23 changes as it rotates under braking and traction forces, due to the differing cantilever deflections discussed above.

The geometry of this suspension 21 provides that the axle 23 twists as the leaf spring 22 deflects under load changes. During roll of the associated vehicle, when the leaf springs 22 on respective opposed ends of the axle 23 attempts to deflect in different directions, the axle 23 rotates in different directions on respective opposed sides of the vehicle frame.

As the axle 23 is normally torsionally stiff, the leaf springs 22 cannot deflect naturally, which causes them to distort. As a result, this distortion causes the springs 22 to deflect by a smaller amount, thus stiffening or increasing the rate of the leaf springs 22, thereby increasing the anti-roll stiffness of the suspension 21.

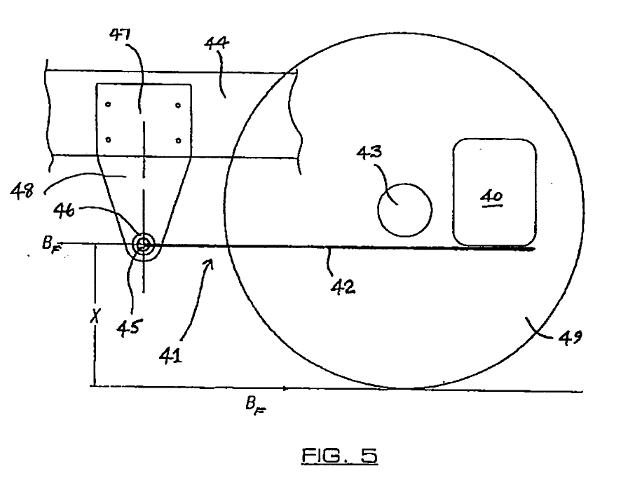

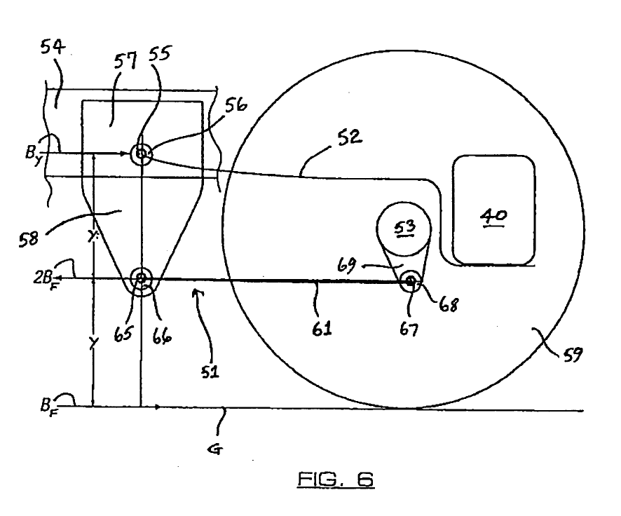

The prior art air suspension 31 shown diagrammatically in FIG. 4 comprises a pair of air spring bags 40 (only one shown) mounted adjacent the rear axle 33 of the associated vehicle. The lateral location of the axle 33 with respect to the vehicle is by means of a lateral or Panhard rod (also not shown), as in the cases of the prior art suspensions to be described hereinbelow in conjunction with FIGS. 5 and 6.

Under braking or traction, the reactive vertical load changes of the mountings, such as the front eye 36 of the leaf spring 32 and the associated bush 35 and bracket 37 connecting the front end of the leaf spring 32 to the frame 34 of the associated vehicle, which resist the braking and traction force moments, have to be higher than in the prior art suspensions discussed above with respect to FIGS. 1 to 3, because they are spaced over a shorter span Lₐ, instead of L for the equivalent length of leaf spring described above in relation to the prior art suspensions 1, 21 of FIGS. 1 and 2 and FIG. 3.

In order to obtain the higher roll stiffness required by air suspensions 31 of this type, the front cantilever of the leaf spring 32 has to be very stiff, thereby creating a very high asymmetrical deflecting cantilever effect with very high torsional loads in the axle 33.

Because this front leaf spring cantilever is very stiff, the instantaneous centre of the axle 33 is very close to the front eye 36 of the leaf spring 32, thereby creating very high axle vertical movements under braking and traction forces which, in turn, produce many adverse performance and attitude effects on the associated vehicle and difficulties associated with propeller drive shaft angle changes.

This short instantaneous centre, virtual cantilever length also creates a very stiff ride, as discussed above. This means that in order to create an improved ride, the air spring 40 has to be made even more flexible, or softer, which compounds the previously-discussed problems.

FIG. 5 shows an improved version of the suspension 31 discussed above in relation to FIG. 4, the improvement being the lowering of the front eye 46 of the front cantilever of the leaf spring 42 to reduce the height X above ground level of the location point of that eye 46. Thus, the braking and traction moments B_{F}X which the suspension and associated components, such as the axle 43 and hanger bracket 47 and associated bush 45, have to absorb, are reduced by lowering the connection of the front eye 46 of the leaf spring 42 to the vehicle frame 44, using a dropper arm 48 of the hanger bracket 47, with the bush and the leaf spring front eye 46 mounted at the lower end thereof.

As discussed above, the main problem created by this type of suspension 41 is that it requires a specially designed and heavier front frame bracket 47. The horizontal forces through the now-lowered front eye 46 of the front cantilever of the leaf spring 42 produce a high moment on to the frame 44, requiring a wider spread of mountings and heavier bracket, frame and cross members. This arrangement also requires a special frame assembly which increases greatly the expense and production disruption created when specifying an air suspension option against a standard leaf spring suspension.

In FIG. 6, there is shown another improved version of air suspension 51 which has been devised to reduce the problems and adverse features associated with the previously-described suspensions.

In that suspension 51, a leaf spring 52 has its front eye 56 connected to the frame 54 via a bush 55 and hanger bracket 57, with an air spring 40 mounted to its other end, similar to the suspension 31 described above in relation to FIG. 4.

However, in this suspension 51, a secondary link 61 is added to create a double link geometry which urges the instantaneous centre forwards with respect to the suspension 51 and frame 54.

This secondary link 61 has a front eye 66 connected, via a bush 65, to an extension 58 of the hanger plate 57. A rear eye 68 of the secondary link 61 is connected pivotally to the axle 53 of the associated vehicle via a bush 67 and a rigid axle bracket 69.

In this prior art example of suspension 51 and for illustration purposes only, the distance Y between the front eye 56 of the leaf spring 52 and the front eye 67 of the secondary link 61 has been made the same as the distance Y between the front eye 67 of the secondary link 61 and ground level G. In this case, the horizontal force (2B_{F}) exerted on the front eye 66 of the secondary link 61 is twice the braking or traction force B_{F} at ground level G. In practice, however, the secondary link front eye 66 is often closer to the front eye 56 of the leaf spring 52, thereby increasing the force exerted upon the eye 66 by an even larger amount, as well as increasing the force on the front eye 56 of the leaf spring 52. Such adversity also creates higher frame loading problems than just lowering the front eye of the leaf spring, as well as the bracketry 57, 58, 69 required to support and control the secondary link 61.

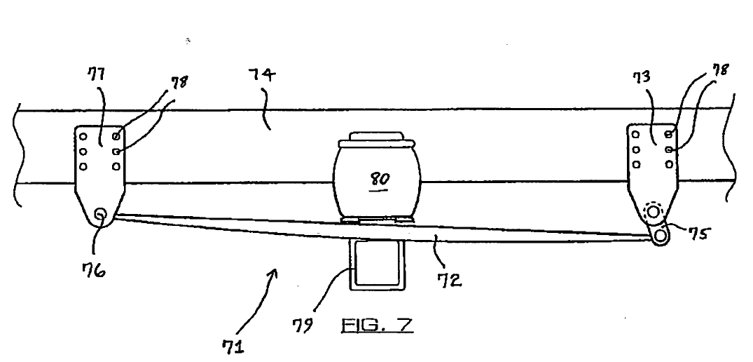

In FIG. 7, there is shown a well known type of air suspension 71 which is often applied to vehicle front end suspensions.

In this particular air suspension 71, the front eye (not shown) of the front cantilever of the leaf spring 72 is connected to the vehicle frame 74 via a bush 76 mounted on a hanger bracket 77 bolted or riveted at 78 to the vehicle frame 74.

The rear eye (also not shown) of the rear cantilever of the leaf spring 72 is connected to the frame 74 via a shackle 75 and an associated hanger bracket 73 which is also connected to the frame 74 by bolts or rivets 78.

The leaf spring 72 is mounted centrally to an axle 79 and has an air spring 80 mounted thereon.

In this prior art example of suspension 71, the regular full weight leaf spring is replaced by a lighter leaf spring 72 which locates the axle 79 and often carries just the unladen vehicle suspension loads. The air spring 80 which, as in this case, is usually located adjacent the axle 79, carries the remainder of the load which is applied to the suspension 71 when the vehicle is loaded.

Thus, this suspension 71 includes a leaf spring 72 and an air spring 80 operating in parallel with each other.

The friction from the leaf spring 72 is again very limited and a high additional anti-roll force is again required.

Basically, the leaf spring 72 still solely provides the only resistance to braking and traction wind-up and as this replacement leaf spring 72 carries only part of the load, it is much lighter than the original arrangement where the leaf spring is used alone.

Thus, control of wind-up of the axle 79 is now a major problem.

Alternatively, the leaf spring 72 can be stiffened-up to create adequate control but as the air spring 80 is now in parallel with the leaf spring 72, the whole suspension would have a very stiff deflection rate which defeats one of the main reasons for specifying such a suspension 71. Such factors can restrict severely the performance of such a suspension 71.

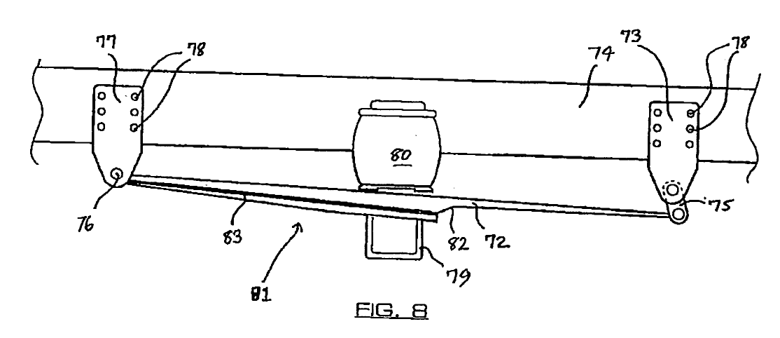

In an attempt to improve at least partially these wind-up and roll stiffness restrictions associated with the suspension 71, the leaf spring can be designed to comparatively high asymmetrical stiffnesses. Such an example is shown in FIG. 8 wherein the suspension 81 comprises substantially the same components as those of the suspension 71 described above in relation to FIG. 7, except that the front cantilever of the leaf spring 72 is stiffened-up and the rear cantilever is softened.

The reduced section at 82 provides softening of the rear cantilever of the leaf spring 72, whilst an additional leaf 83 is provided between the front eye (not shown) of the front cantilever of the leaf spring 72 and the axle 79. This front cantilever stiffening could also be created by just thickening the front cantilever of the main leaf, without the need for the additional leaf 83.

This arrangement of air suspension 81 employs the previously-discussed high asymmetric roll stiffness and comparatively high stiffness of the front cantilever of the leaf spring 72, to prevent axle wind-up, to control the axle 79. The effect is to reduce heavily the ride quality of the vehicle, whilst also creating a very inefficient use of spring steel. As a consequence, this particular arrangement of suspension 81 has all the adverse characteristics of the previously-discussed suspension 31 of FIG. 4.

In some cases, the rear cantilever of the leaf spring 72 can be removed completely, with transverse location of the axle 79 being provided by a transverse or Panhard rod linkage. The presence of the rod linkage can create installation problems with vehicle components, such as engines and gearboxes.

An improvement over the prior art examples discussed above is taught in our European Patent No. 1185428, wherein the leaf springs are stiffened only during vehicle roll to control the stability and handling of the vehicle at acceptable cost and weight increases. However, to gain the maximum advantage from this improvement, the leaf springs still need extra wind-up control when subjected to braking and traction forces.

### DETAILED DESCRIPTION OF THE PREFERRED EMBODIMENTS

Referring now to FIGS. 9 and 10 of the accompanying drawings, here is shown a first embodiment of vehicle suspension 91 in accordance with the invention, which comprises a pair of double leaf springs 92.

The front eye 96 of the front cantilever of each upper leaf spring 92′ is connected to the associated vehicle frame (not shown) via a bush 95 mounted with respect to a front hanger bracket 97.

The rear eye 105 of the rear cantilever of each upper leaf spring 92′ is connected to the vehicle frame by means of a shackle 106 mounted pivotally at 108 to a rear hanger bracket 107.

Mounted intermediate each pair of front and rear hanger brackets 97, 107, each double leaf spring 92 is clamped rigidly to the transverse axle 93 of the associated vehicle. In turn, further suspension means in the form of an air spring 111 is mounted to each double leaf spring 92 above and adjacent the corresponding end of the axle 93, with the upper end of each air spring 111 being connected rigidly to a frame bracket 112.

In accordance with the invention, a radius arm in the form of a leaf spring 114 has a front eye 113 connected pivotally at bush 115 to the lower end of an extension hanger bracket 116 whose upper end is connected rigidly to the double leaf spring 92 at or adjacent the front eye 96 of the upper leaf spring 92 which is connected by a bush 95 to the front hanger bracket.

At the rear end of each radius leaf spring arm 114, there is provided a rear eye 117 which is pivotally attached by a bush 118 to the lower end of an axle bracket 119 whose upper end is attached rigidly to the axle 93.

Optionally, a shock absorber mounting eye for the suspension 91, such as that shown at 120, may be provided, possibly along with an anti-roll unit indicated generally at 130. Such unit 130 may comprise a stabilizer bar or tube 131 having respective opposed ends clamped at 132 to the front cantilever of the double leaf spring 92′.

As this first embodiment of suspension 91 in accordance with the invention is mounted to the double leaf spring 92 and assembly for the axle 93, the whole can be mounted to the associated vehicle frame without changing the mountings for a conventional leaf spring suspension.

The geometry of the radius leaf spring arm 114, the front cantilever of the double leaf spring 92 and the front and axle brackets 116, 119 can be designed to match exactly the geometry of deflection of the leaf springs 92, although this can be complicated by the movement of the front eye 113 of the radius arm 114 during spring deflection. However, it has been found that with accurate analysis, these geometries can be matched.

During spring wind-up, however, when the suspension 91 is subjected to braking and traction forces, the geometries tend to mis-match, thus preventing the spring 92 deflecting adversely, thereby limiting axle wind-up problems.

During braking and traction, the resistance to wind-up creates tension or compression along the radius leaf spring arm 114. Therefore, the degree of wind-up stiffness can be varied by adjusting the compliance in the bushes 115, 118 at the front and rear ends of the arm 114, about which the front and rear eyes 113, 117 of the arm 114 are pivotable. Alternatively, the arm 114 can be allowed to flex which can be achieved by making the arm 114 form a flat or curved leaf spring section, whereby peak shock loads can be removed substantially from the suspension 91.

An alternative might be to create a degree of mis-match between the geometries of the double leaf spring 92 and the radius leaf spring arm 114 and associated components, during straight deflection. This effect can be employed to create different suspension characteristics during operation of the suspension 91 and, again, can be modified using the compliance in the front and rear bushes 115, 118, of the arm 114, as discussed above.

An example of this suspension characteristic change could be to obtain a better match to the steering or the axle drive propeller shaft.

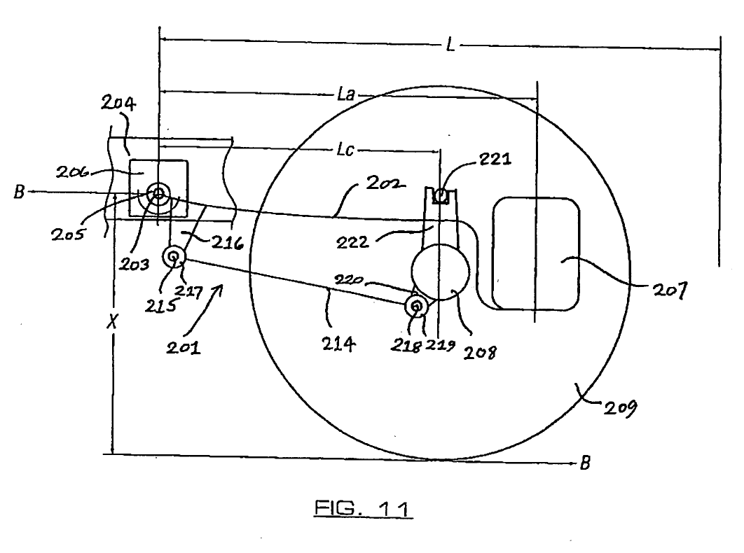

The second embodiment of suspension 201 shown in FIG. 11 comprises a leaf spring 202 whose front eye 205 is connected to the associated vehicle frame 204 via a bush 203 and frame bracket 206.

Mounted to the rear end of the leaf spring 202 is further suspension means in the form of an air spring 207, with an axle 208 and associated running wheel 209 provided.

As in the case of the prior art suspensions of FIGS. 4 to 6, the transverse location of the axle 208 can be provided by any suitable means. In the embodiment shown in FIG. 11, such means is shown diagrammatically at 221 as a transverse location or Panhard rod fastened to an axle bracket 222 which is mounted rigidly to the axle 208. The other end of the rod 221 is connected pivotally to a frame bracket (not shown).

In accordance with the invention, a radius leaf spring arm 214 has a front eye 217 pivotally connected to the lower end of an extension bracket 216 via a bush 215. The upper end of the bracket 216 is connected rigidly to the leaf spring 202 adjacent the front eye 205 thereof.

The rear eye 219 of the radius leaf spring arm 214 is connected pivotally by a bush 218 to an axle bracket 220 which, in turn, has its upper end fixed rigidly to the axle 208 or an associated axle assembly.

The leaf spring of each radius arm 214 may be replaced with a rod connected pivotally to the axle bracket 220.

This innovative arrangement could also be applied to a soft leaf spring suspension or any other combined leaf and other spring medium suspension, such as those of the prior art suspensions discussed above.

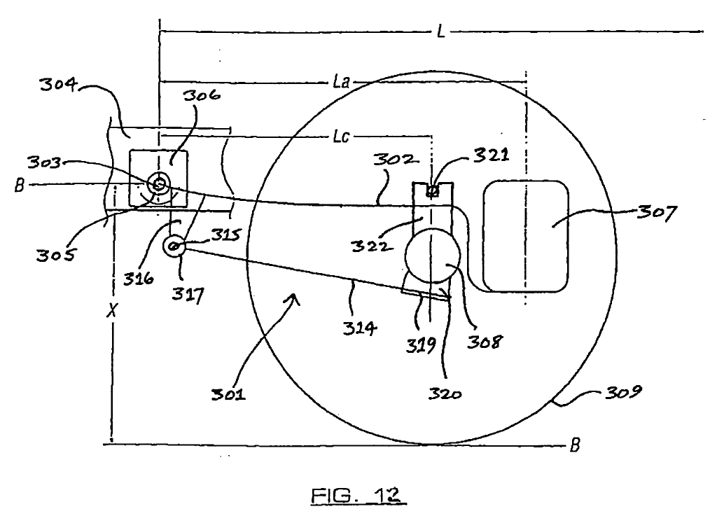

A third embodiment of suspension 301 shown in FIG. 12 comprises a leaf spring 302 whose front eye 305 is connected to the associated vehicle frame 304 via a bush 303 and frame bracket 306, in a similar manner to the corresponding components of the second embodiment of suspension 201 of FIG. 11.

Mounted to the rear end of the leaf spring 302 is further suspension means in the form of an air spring 307, with an axle 308 and associated running wheel 309 provided, again in a similar manner to the second embodiment of suspension 201 of FIG. 11.

As in the case of the prior art suspensions of FIGS. 4 to 6 and the second embodiment of FIG. 11, the transverse location of the axle 208 can be provided by any suitable means. In this third embodiment shown in FIG. 12, such means is again shown diagrammatically at 321 as a transverse location or Panhard rod fastened to an axle bracket 322 which is mounted rigidly to the axle 308. The other end of the rod 321 is connected pivotally to a frame bracket (not shown).

In accordance with the invention, a radius leaf spring arm 314 has a front eye 317 pivotally connected to the lower end of an extension bracket 316 via a bush 315.

The upper end of the bracket 316 is connected rigidly to the leaf spring 302 adjacent the front eye 305 thereof.

The rear end 319 of the radius leaf spring arm 314 is connected rigidly to an axle bracket 320 which, in turn, has its upper end fixed rigidly to the axle 308 or an associated axle assembly.

It is to be appreciated that the air springs 111, 207, 307 of the three embodiments described above with reference to FIGS. 9 and 10, 11 and 12 could be replaced or used in combination with other forms of further suspension means, for example, an elastomeric spring or a coil spring.

The suspensions discussed above in accordance with the invention provide an effective linkage to control wind-up without the need for any extra frame structure and can be assembled to the vehicle frame as a direct replacement for a conventional leaf spring suspension, without requiring any extra frame brackets and frame strengthening which the current air suspension applications require.

Also, the inventive suspensions allow for an effectively controlled, high quality air suspension using soft-rated leaf springs and this application can employ symmetrical springs and could be used in the prior art suspension disclosed in our European Patent No. 1185428, as discussed above. The novel linkage provided by the radius arm of suspensions discussed above in accordance with the invention would be able to control spring wind-up under braking and traction loading and forces and the suspension and axle assembly could be installed to the vehicle frame in the same way as that of an equivalent conventional leaf spring suspension. Using this arrangement, the suspension could also use softer springs and thus improve ride quality.

Further, suspensions in accordance with the invention could also be used with high ride, quality leaf spring only suspensions and it could also be used with suspensions which are controlled by leaf springs using further suspension means, such as air, elastomeric and/or coil springs, either in parallel or series with the leaf springs.

The linkage afforded by the radius arm may also be used to alter the leaf spring deflection characteristics in other ways, for example, by selecting the linkage geometry to match the associated leaf cantilever geometry or by choosing a required mis-match. Any such mis-match could then be modified by the linkage's compression or tension stiffness. This degree or rate of compression or tension stiffness can also be used to reduce the peak stresses in the attachments and other components of the suspension.

In its simplest geometric form, the linkage can match the spring cantilever geometry during leaf spring deflection. That is to say, it can allow the spring cantilever to deflect under increasing and decreasing loads without any resistance from the linkage.

Thus it can be seen that the invention accomplishes at least all of its objectives.

I claim:

1. A vehicle suspension comprising:
a pair of leaf springs arranged to extend longitudinally of a frame of an associated vehicle on respective opposed sides thereof, each leaf spring having one of its ends connectable pivotally to the vehicle frame at a fixed location with respect thereto and arranged to have mounted thereto intermediate its ends an axle extending transversely of the vehicle frame;
a first bracket attached rigidly to each leaf spring at or adjacent the fixed location at which the one end of each leaf spring is connectable pivotally to the vehicle frame;
a radius arm arranged to extend longitudinally on each side of the vehicle frame and having one end thereof connected pivotally to the first bracket in spaced relationship to said fixed location;
and a second bracket which is attachable rigidly to the axle and to which is connected the other end of the corresponding radius arm in spaced relationship to the axle.

2. A suspension according to claim 1 wherein the other end of each leaf spring is connectable to the associated vehicle frame for linear movement with respect thereto, to account for length changes of the spring under load conditions.

3. A suspension according to claim 1 wherein the one end of each radius arm is connected pivotally to its respective first bracket by means of a bushing.

4. A suspension according to claim 3 wherein the other end of each radius arm is connected pivotally to the corresponding second bracket.

5. A suspension according to claim 3 wherein the other end of each radius arm is connected rigidly to the corresponding second bracket.

6. A suspension according to claim 1 wherein each second bracket is attachable rigidly to an axle assembly of an associated vehicle.

7. A suspension according to claim 6 wherein each second bracket is attachable rigidly to the axle assembly by at least one U-bolt.

8. A suspension according to claim 1 wherein each leaf spring, the corresponding first and second brackets and radius arm spaced from the leaf spring, form a linkage which is generally parallelogram-shaped.

9. A suspension according to claim 8 wherein the linkage can be tuned to the operative requirements of the suspension.

10. A suspension according to claim 9 wherein the front cantilever of each leaf spring forms part of the generally parallelogram linkage.

11. A suspension according to claim 1 including symmetrical or asymmetrical leaf springs.

12. A suspension according to claim 1 wherein the radius arm comprises a rod or leaf spring.

13. A suspension according to claim 1 including further suspension means.

14. A suspension according to claim 13 wherein said further suspension means is parallel to each leaf spring.

15. A suspension according to claim 14 wherein said further suspension means is mountable to the axle.

16. A suspension according to claim 15 wherein said further suspension means is mounted to each leaf spring.

17. A suspension according to claim 13 wherein said further suspension is in series with each leaf spring.

18. A suspension according to claim 17 wherein said further suspension means is mountable to the axle.

19. A suspension according to claim 17 wherein said further suspension means is mounted to each leaf spring.

20. A suspension according to claim 19 wherein said further suspension means is mounted to the end of each leaf spring remote from said one end thereof.

21. A suspension according to claim 13 wherein said further suspension means comprises an air spring, elastomeric spring or coil spring or any combination thereof.

22. A vehicle suspension assembly comprising a vehicle suspension and an axle, the vehicle suspension comprising:
a pair of leaf springs arranged to extend longitudinally of a frame of an associated vehicle on respective opposed sides thereof, each leaf spring having one of its ends connectable pivotally to the vehicle frame at a fixed location with respect thereto and having mounted thereto intermediate its ends the axle which is arranged to extend transversely of the associated vehicle frame;
a first bracket attached rigidly to each leaf spring at or adjacent the fixed location at which the one end of each leaf spring is connectable pivotally to the vehicle frame;
a radius arm arranged to extend longitudinally on each side of the vehicle frame and having one end thereof connected pivotally to the first bracket in spaced relationship to said fixed location; and
a second bracket which is attachable rigidly to the axle and to which is connected the other end of the corresponding radius arm in spaced relationship to the axle.

23. A suspension assembly according to claim 22 wherein the one end of each leaf spring includes an eye which is connectable pivotally to the frame *of an associated vehicle at the fixed location with respect thereto by means of a bush which is mountable in a hanger bracket fixable or fixed rigidly to the associated vehicle frame.

24. A suspension assembly according to claim 22 wherein the other end of each leaf spring is connectable to the associated vehicle frame for linear movement with respect thereto, to account for length changes of the spring under load conditions.

25. A suspension assembly according to claim 24 wherein the other end of each leaf spring is connectable to the associated vehicle frame by means of a bushing, shackle, slider bracket or air spring bag.

26. A suspension assembly according to claim 22 wherein the one end of each radius arm is connected pivotally to its respective first bracket by means of a bushing.

27. A suspension assembly according to claim 22 wherein the other end of each radius arm is connected pivotally to the corresponding second bracket.

28. A suspension assembly according to claim 22 wherein the other end of each radius arm is connected rigidly to the corresponding second bracket.

29. A suspension assembly according to claim 22 wherein each second bracket is attached rigidly to an axle assembly of an associated vehicle.

30. A suspension assembly according to claim 22 wherein each leaf spring, the corresponding first and second brackets and radius arm spaced from the leaf spring, form a linkage which is generally parallelogram-shaped.

31. A suspension assembly according to claim 30 wherein the linkage can be tuned to the operative requirements of the suspension.

32. A suspension assembly according to claim 30 wherein the front cantilever of each leaf spring forms part of the generally parallelogram linkage.

33. A suspension assembly according to claim 22 including symmetrical or asymmetrical leaf springs.

34. A suspension assembly according to claim 22 wherein the radius arm comprises a rod or leaf spring.

35. A suspension assembly according to claim 22 including further suspension means.

36. A suspension assembly according to claim 35 wherein said further suspension means is in parallel with each leaf spring.

37. A suspension assembly according to claim 36 wherein said further suspension means is mountable to the axle.

38. A suspension assembly according to claim 36 wherein said further suspension means is mounted to each leaf spring.

39. A suspension assembly according to claim 35 wherein said further suspension is in series with each leaf spring.

40. A suspension assembly according to claim 39 wherein said further suspension means is mountable to the axle.

41. A suspension assembly according to claim 40 wherein said further suspension means is mounted to each leaf spring.

42. A suspension assembly according to claim 41 wherein said further suspension means is mounted to the end of each leaf spring remote from said one end thereof.

43. A vehicle comprising a frame, a suspension and an axle, the suspension comprising:
a pair of leaf springs extending longitudinally of the frame of the vehicle on respective opposed sides thereof, each leaf spring having one of its ends connectable pivotally to the vehicle frame at a fixed location with respect thereto and having mounted thereto intermediate its ends the axle which is arranged to extend transversely of the associated vehicle frame;
a first bracket attached rigidly to each leaf spring at or adjacent the fixed location at which the one end of each leaf spring is connected pivotally to the vehicle frame;
a radius arm extending longitudinally on each side of the vehicle frame and having one end thereof connected pivotally to the first bracket in spaced relationship to said fixed location; and
a second bracket which is attachable rigidly to the axle and to which is connected the other end of the corresponding radius arm in spaced relationship to the axle.

44. A vehicle according to claim 43 wherein the one end of each leaf spring includes an eye which is connected pivotally to the frame of the vehicle at the fixed location with respect thereto by means of a bushing which is mounted in a hanger bracket fixed rigidly to the vehicle frame.

45. A vehicle according to claim 44 wherein the other end of each leaf spring is connected to the vehicle frame for linear movement with respect thereto, to account for length changes of the spring under load conditions.

46. A vehicle according to claim 43 wherein the other end of each radius arm is connected pivotally to the corresponding second bracket.

47. A vehicle according to claim 43 wherein the other end of each radius arm is connected rigidly to the corresponding second bracket.

48. A vehicle according to claim 43 wherein each second bracket is attached rigidly to an axle assembly of the vehicle.

49. A vehicle according to claim 43 wherein each leaf spring, the corresponding first and second brackets and radius arm spaced from the leaf spring, form a linkage which is generally parallelogram-shaped.

50. A vehicle according to claim 49 wherein the linkage can be tuned to the operative requirements of the suspension.

51. A vehicle according to claim 49 wherein the front cantilever of each leaf spring forms part of the generally parallelogram linkage.

52. A vehicle according to claim 43 including symmetrical or asymmetrical leaf springs.

53. A vehicle according to claim 43 including further suspension means.

54. A vehicle according to claim 53 wherein said further suspension means is in parallel with each leaf spring.

55. A vehicle according to claim 54 wherein said further suspension means is mountable to the axle.

56. A vehicle according to claim 55 wherein said further suspension means is mounted to each leaf spring.

57. A vehicle according to claim 53 wherein said further suspension is in series with each leaf spring.

58. A vehicle according to claim 57 wherein said further suspension means is mountable to the axle.

59. A vehicle according to claim 57 wherein said further suspension means is mounted to each leaf spring.

60. A vehicle according to claim 59 wherein said further suspension means is mounted to the end of each leaf spring remote from said one end thereof.
